(19) United States
(12) Patent Application Publication
(10) Pub. No.: US 2015/0134851 A1
(43) Pub. Date: May 14, 2015

(54) GEOTAGGED COMMUNICATIONS IN NETWORK SYSTEMS AND COMPONENTS

(71) Applicant: Broadcom Corporation, Irvine, CA (US)

(72) Inventors: SANDEEP KUMAR RELAN, BANGALORE (IN); Vijay Anand Purushothaman, Bangalore (IN); Tarun Kumar Varshney, Bangalore (IN); Mohan Venkatachar Kalkunte, Saratoga, CA (US); Wael William Diab, San Francisco, CA (US)

(73) Assignee: Broadcom Corporation, Irvine, CA (US)

(21) Appl. No.: 14/086,269

(22) Filed: Nov. 21, 2013

Related U.S. Application Data
(60) Provisional application No. 61/904,089, filed on Nov. 14, 2013.

(51) Int. Cl. H04L 12/733; H04L 29/08

(52) U.S. Cl. CPC H04L 45/126; H04L 67/18
USPC 709/241

(57) ABSTRACT

Aspects of geotagged communications are described herein. In one embodiment, a data unit including a geotag field is received over an ingress port of a network component. In turn, the network component may determine a path for forwarding the data unit to a location associated with the geotag field and with reference to a forwarding decision index. The path may include a least distance hop or a least distance route for forwarding or routing the data unit. With reference to the forwarding path, the network component may identify an egress port for forwarding the data unit. The network component may also forward the data unit over the egress port. According to other aspects, geolocation data may enable a network component to implement geotag-based virtual local area networks, geotag-based multiprotocol label switching, geotag-based fault detection and isolation, or geotag-based firewalls and fencing in wired routers or switches, for example.

### BACKGROUND

This application claims the benefit of U.S. Provisional Application No. 61/904,089, filed Nov. 14, 2013, the entire contents of which is hereby incorporated herein by reference.

Among other functions, a network component, such as a network router, switch, etc., routes or switches data from a source to a destination. For example, a network switch may receive network data units on one or more ingress ports and route or switch these data units to one or more egress ports. According to various network communications protocols, forwarding paths for ingress data units may be identified according to suitable forwarding, routing or switching tables, protocols, and priorities for data transfer.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 illustrates an example system including a network and network components that operate using geotagging according to an example embodiment.

FIG. 2 illustrates an example network component that operates according to geotagged communications in the system of FIG. 1 according to an example embodiment.

FIG. 3 illustrates an example network data unit which may be relied upon in geotagged communications in the system of FIG. 1 according to an example embodiment.

FIG. 4 illustrates another example network data unit which may be relied upon in geotagged communications in the system of FIG. 1 according to an example embodiment.

FIG. 5 illustrates an example system including a label switched network and label switched network components that operate using geotagging according to an example embodiment.

FIG. 6 illustrates an example network data unit which may be relied upon in label switched geotagged communications in the system of FIG. 5 according to an example embodiment.

FIG. 7 illustrates an example system including a network that operates according to a geolocation firewall using geotagging according to an example embodiment.

FIG. 8 illustrates a process of geotagged communications which may be performed by a network component described herein according to an example embodiment.

FIG. 9 illustrates an example schematic block diagram of a computing architecture which may be employed by a network component described herein according to various embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions or positions of elements and features may be exaggerated to help visually convey certain principles. In the drawings, similar reference numerals between figures designate like or corresponding, but not necessarily the same, elements.

### DETAILED DESCRIPTION

In the following paragraphs, various embodiments are described in further detail by way of example with reference to the attached drawings. In the description, well known components, methods, and/or processing techniques are omitted or briefly described so as not to obscure the embodiments.

Conventional network routing and switching components are based on the OSI layer model of data transmission, with physical and/or logical routing parameters being defined by IEEE, IETF/RFC, ITU and other international standard bodies. These network components do not consider geolocation data in the context of data routing or switching in networks. Instead, for the most part, the physical and/or logical routing or switching parameters are embodied as arbitrary numerical values which have little, if any, relationship to physical positions of network elements or end devices. For example, layer 2 media access control (MAC) addresses identify source and destination addresses of devices or chipsets but are not representative of geographic locations of the source or destination devices. Similarly, layer 3 internet protocol (IP) addresses (e.g., IPv4 addresses), which were allocated at a broader region level, are now being reused and repurposed among different regions. Thus, there is little certainty that an IP address is associated with a particular geographic location.

Turning now to the drawings, a description of exemplary embodiments of a system and its components are provided, followed by a discussion of the operation of the same.

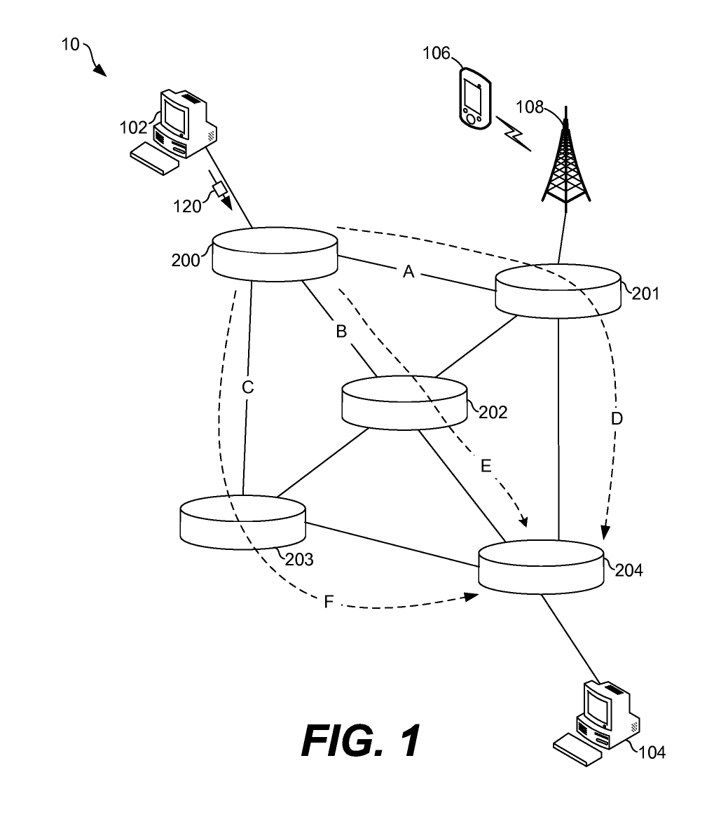

FIG. 1 illustrates an example system 10 including a network and network components that operate using geotagging according to an example embodiment. The system 10 includes computing devices 102, 104, and 106, and network components 200-204 (i.e., “the network”). The system 10 also includes a wireless access point 108 which may be embodied as any suitable wireless communications access point, such as a wireless local area network (WLAN) access point or a cellular remote radio head (RRH), for example, without limitation. The network provides a structure by which data may be communicated between the computing devices 102, 104, and 106. In this context, the network component 200 (and the other network components 201-204) may be embodied as a type of network switch, router, hub, bridge, gateway, firewall or other similar network component or combination thereof, without limitation. According to certain features described herein, the network components 200-204 may be considered geolocation-aware network components.

In various embodiments, the computing devices 102, 104, and 106 (and other “computing devices” described herein) may be embodied as any type of computing device, such as a desktop or laptop computer, a server computer, a cellular telephone, a tablet computing device, a portable media player, a digital camera, etc., without limitation. In this sense, the network illustrated in FIG. 1 (and the other networks described herein) may include a heterogeneous mix of computing devices. It should also be appreciated that the computing devices 102, 104, and 106 (and other computing devices) may be connected to the network via any suitable communication channel, such as Ethernet, cable, digital subscriber line (DSL), etc.

According to one aspect of geotagged communications described herein, the computing device 102 transmits a data unit 120, including at least one geotag field, to the network component 200 for communication to the computing device 104. As further described herein, the geotag field includes geographic location (i.e., “geolocation”) information or data representative of a physical geographic location of the computing device 104. The geotag field may be relied upon as a destination address for the data unit 120. In some embodiments, the geotag field may also include a physical geographic location of the computing device 104, as a source address of the computing device 102. It is noted that, in addition to payload data and the geotag field, the data unit 120 may also include other fields, headers, flags, physical (e.g., MAC addresses) and/or logical (e.g., IPv4 or IPv6) address identifiers, or other data, without limitation.

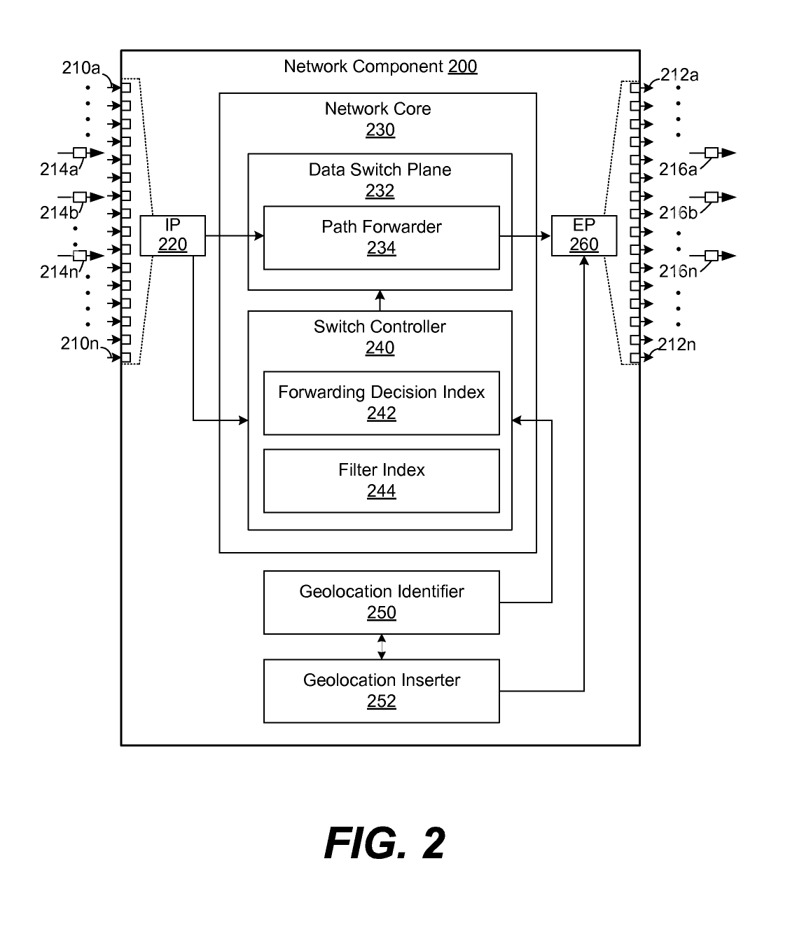

The network components 200-204 route, switch, or forward data units in the network with reference to geolocation data. For example, when the network component 200 receives the data unit 120 from the computing device 102 over an ingress port, the network component 200 refers to a forwarding decision index based on the geotag field, and identifies an egress port for the data unit. Further features and aspects of the network component 200 are described below with reference to FIG. 2.

FIG. 2 illustrates the network component 200 that operates according to geotagged communications in the system 10 of FIG. 1 according to an example embodiment. It is noted that the other network components 201-204 in the system 10 may be similar to the network component 200. Among other aspects, the network component 200 may receive a data unit over an ingress port, process the data unit according to priorities, protocols, filters, etc., make forwarding, routing, or switching decisions for the data unit, and forward the data unit over an egress port. In this context, the network component 200 facilitates geotagged data communications by receiving data and transmitting data units in connection with geolocation data.

While the network component 200 is described as operating with data units, it should be appreciated that the network component 200 is not limited to operating with any particular type, style, or standard data unit or data container. In this context, it should be appreciated that the network component 200 may operate between and among various layers of network abstraction. For example, the network component 200 may operate on data units communicated at or among various layers of the open systems interconnection (OSI) model, including the physical, data, network, transport, session, etc. layers.

The network component 200 includes one or more input or ingress ports 210a-210n, one or more output or egress ports 212a-212n, an ingress processor 220, a network core 230, an egress processor 260, a geolocation identifier 250, and a geolocation inserter 252. The elements of the network component 200 may be embodied as one or more general- or specific-purpose circuits, processing circuits, memories or any combination thereof. The network component 200 may receive data units 214a-214n on any of the ingress ports 210a-210n. Further, the network component 200 may transmit data units 216a-216n on any of the egress ports 212a-212n. As would be appreciated, it is noted that a pair of ingress and egress ports (e.g., 210a and 212a, 210b and 212b, etc.) may be representative of a single physical port of the network component 200 which is operable for both the reception and transmission of data packets.

The ingress processor 220 receives and processes the data units 214a-214n. For example, the ingress processor 220 may read or extract payload data from one or more of the data units 214a-214n, and provide this payload data to the network core 230. Additionally, the ingress processor 220 may read or extract source and destination headers, geotag fields, and other information from the data units 214a-214n, and provide this information to the network core 230. The ingress processor 220, in connection with the network core 230, may examine, evaluate, and adhere to protocol control fields, headers, flags, and other data syntax structures in received data units, to coordinate operations of the network component 200.

The egress processor 260 prepares the data units 216a-216n for outbound transmission via one or more of the egress ports 212a-212n. For example, the egress processor 260 may append header, address, label, or other forwarding, routing, or switching information to payload data, as directed by the network core 230, so that the data units 216a-216n may be routed to other downstream network components. Further, the egress processor 260 may set control bits or flags in headers, calculate redundancy check checksums, etc.

The network core 230 supports the operation of the network component 200 and includes a data switch plane 232 and a switch controller 240. The data switch plane 232 includes processing circuit elements related to forwarding, routing, or switching data units from ingress to egress paths, and the switch controller 240 includes processing circuit elements related to making decisions for forwarding, routing, or switching the data units from the ingress to the egress paths. Among other elements, the data switch plane 232 includes the path forwarder 234, which may be embodied as general- or specific-purpose circuitry and/or memory that communicatively couples data units from certain ingress paths to certain egress paths, as directed by the switch controller 240. Further, among other elements, the switch controller 240 includes the forwarding decision index 242 and the filter index 244. The forwarding decision index 242 may be embodied as general- or specific-purpose circuitry and/or memory that develops and maintains one or more forwarding or routing tables, for example, or combinations thereof.

The forwarding decision index 242 may include information (e.g., tables, arrays, matrixes, and/or other similar data structures) which are representative of the structure of a network in which the network component 200 resides. That is, the forwarding decision index 242 may store network address, forwarding, and routing information in one or more tables which define or identify paths to other network components. The paths may be defined in connection with the ingress and egress ports 210a-210n and 212a-212n, for example, in connection with associated geolocation information. The paths may include next hop and route paths, for example, and may take geographic location information into account. In certain aspects, the forwarding decision index 242 may store network address, forwarding, routing, or switching information for other network components in terms of geographic location data. In other words, rather than (or in addition to) associating certain ingress and egress ports with physical or logical addresses of other network components, the forwarding decision index 242 may store at least certain forwarding, routing, or switching information in terms of geographic location data. This information may be stored in the form of relative and/or absolute geographic position information, geographic distance information, etc. The information stored by the forwarding decision index 242 may be populated by the network component 200 using any suitable network topology discovery processes and/or address resolution protocols.

The filter index 244 may include information (e.g., tables, arrays, matrixes, and/or other similar data structures) which are representative of one or more virtual perimeters or geographic boundaries, QOS level priority considerations, geolocation-related protocols or rules, or data unit prioritization or drop rules, for example, which may be relied upon by the network component 200 to make forwarding, routing, or switching decisions.

The geolocation identifier 250 may be embodied as a global navigation satellite system (GNSS) device, module, or chipset that generates geolocation data based on a geographic location of the network component 200. The geolocation data generated by the geolocation identifier 250 is provided to the switch controller 240, for updating and maintaining the forwarding decision index 242 and/or the filter index 244. This geolocation data may be used in various manners and/or capacities by the network component 200. For example, the geolocation data may be used to evaluate relative or absolute proximity to other network components for path selection, routing, or switching, populate a source destination address field in an egress data unit, determine virtual local area network (VLAN) associations, evaluate relative or absolute proximity to other network components for debugging, determine quality of service (QOS) parameters for data units, apply firewall rules, etc. In certain embodiments, the geolocation identifier 250 may be omitted, and the network component 200 may be manually configured with geolocation data. For example, if the network component 200 is installed at a location, the geolocation identifier 250 may be omitted to save costs if it may be assumed that the network component 200 is not mobile or will not move.

The geolocation inserter 252 may be configured to insert one or more geotag fields into data units. For example, the geolocation inserter 252 may receive geolocation data generated by the geolocation identifier 250 and, based on this geolocation data, insert a source location geotag into an outgoing or egress data unit. In this manner, the network component 200 may rely upon the geolocation inserter 252 to insert one or more geotags, as necessary, within data units being transmitted by the network component 200.

In the context of geodesy and geolocation data, it is noted that a geographic coordinate system may be used to specify a location of the network component 200 on Earth. The coordinate system may reference, for example, a vertical position (e.g., latitude), a horizontal position (e.g., longitude), and an elevation. To the extent that the coordinates are defined specifically and/or with precision, a physical location on Earth may be more accurately identified. Thus, a geographic location on Earth may be identified by a latitude and longitude pair, for example, and the granularity of precision in the location may be determined according to the precision by which the latitude and longitude pair is defined.

The geographic location of the network component 200 and/or one or more elements in the system 10 (FIG. 1) may be determined using long range radio navigation (LORAN) or GNSS technologies, such as the global positioning system (GPS), the Galileo positioning system, the COMPASS positioning system, the GLONASS positioning system, the IRNSS positioning system, etc. Additionally or alternatively, the locations of the network component 200 (and other elements in the system 10) may be determined using an indoor-based, metropolitan beacon system (MBS), or other terrestrial location positioning technology. To this end, similar to the network component 200, one or more of the computing devices 102 and 104 and the network components 201-204 (FIG. 1) may include a geolocation identifier, module, or chipset that generates geolocation data representative of the geographic location of the device or component. In some embodiments, elements in the system 10 may be manually programed with geolocation data. For example, when the network components 200-204 are installed, they may be manually configured to store geolocation data specifying installation locations. In other words, if one of the network components 200-204 does not include a geolocation identifier device (e.g., to save cost), then the component may be manually configured with geolocation data that specifies its geographic location.

Generally, longitude and latitude are divided into degrees (°), minutes (′), and seconds (″), which may be represented in decimal degrees. That is, the geographic location of 12°, 55′, and 36.804″ N, 77°, 40′, and 49.224″ E may be represented in decimal degrees as 12.92689°, 77.68034°. Depending upon the number of decimal places used to specify a latitude and longitude pair in decimal degrees, a geographic location may be determined to an accuracy range of about 100 Km, 10 Km, 1 Km, 100 m, 10 m, 1 m, 100 mm. etc. For example, in decimal degrees, 6 decimal positions provide location accuracy to the range of millimeters.

Depending on a suitable level of accuracy, a geotag field in a data unit may be embodied as a certain number of bytes or bits. The number of bits may be budgeted among one or more geotag fields. For example, for 1 byte (8 bits) of data, accuracy to a first range in one coordinate may be determined, and 2 bytes are needed for a latitude and longitude pair. When more bytes of data are relied upon, further accuracy may be provided. Accuracy to the centimeter or millimeter range can be achieved if more bytes of data are relied upon to specify geolocation data. In certain embodiments, compression or encoding techniques may be relied upon to provide higher accuracy in location data, while relying upon fewer bits.

Referring between FIGS. 1 and 2, the network components 200-204 generally route, switch, or forward data units in the network, as described above. For example, when the network component 200 receives the data unit 120 from the computing device 102 over an ingress port, the network component 200 refers to the forwarding decision index 242, for example, to identify an egress port for the data unit 120. According to aspects of geotagged communications described herein, the network component 200 may refer to the forwarding decision index 242 using the geotag field as a type of index to a reverse-lookup forwarding table. In certain embodiments, the network component 200 may also identify or evaluate a forwarding path, route, or class based on the geotag field. The network component 200 may also perform other network functions based on the geotag field, such as assign the data unit 120 to a virtual local area network (VLAN), drop the data unit 120, filter the data unit 120, or prioritize the data unit 120 (e.g., according to a QOS metric).

After receiving the data unit 120, the network component 200 determines one of the paths A, B, or C over which to forward the data unit 120 based on the geotag field. Here, the paths A, B, and C are representative of a first hop from the network component 200 to the computing device 104, and each may be associated with one of the egress ports 212a-212n of the network component 200. As illustrated in FIG. 1, the path A extends between the network component 200 and the network component 201, the path B extends between the network component 200 and the network component 202, and the path C extends between the network component 200 and the network component 203.

The forwarding decision index 242 of the network component 200 may organize and maintain the information by which one of the paths A, B, or C may be chosen, and the switch controller 240 may select one of the paths with reference to the forwarding decision index 242. For example, with reference to the forwarding decision index 242, the switch controller 240 may evaluate a least distance hop metric, a least distance route metric, a geographic inclusion metric, a geographic exclusion metric, or another metric described herein. Depending upon the extent of the information stored in the forwarding decision index 242, the network transfer protocol, or the operating parameters or structure of the network, the switch controller 240 may determine a next hop in the network towards the computing device 104. The next hop may be determined based on the evaluation of a least distance hop metric, a geographic hop inclusion metric, or a geographic hop exclusion metric, for example. Alternatively or additionally, the network component 200 may determine a route in the network to the computing device 104. The route may be determined based on an evaluation of a least distance route metric, a geographic route inclusion metric, or a geographic route exclusion metric, for example.

As one example, the switch controller 240 may select path B for communication of the data unit 120 towards the computing device 104, after identifying that the network component 202 is closer in geographic proximity to the computing device 104 than either of the network components 201 or 203, based on the geotag field in the data unit 120 and the geographic information in the forwarding decision index 242. In this case, the switch controller 240 may reference the forwarding decision index 242 to identify geographic position information associated with each of the “next hop” network components 200-203. In turn, the switch controller 240 may evaluate which of the network components 200-203 is closest in geographic proximity to the computing device 104. Using the information in the forwarding decision index 242, path B may be selected as a least distance (to the computing device 104) hop among paths A, B, and C.

Alternatively or additionally, the switch controller 240 may reference the forwarding decision index 242 to identify one or more of the network components 201-203 to include or exclude. In other words, the network component 200 may be configured to route certain data units to certain geographic locations. The geographic locations may include certain municipalities, cities, states, countries, or regions thereof, for example. Alternatively, the network component 200 may be configured to avoid routing or switching certain data units to certain geographic locations. The geographic locations to exclude or avoid may include municipalities, cities, states, countries, or regions thereof, for example.

As another example, the switch controller 240 may select route E for communication of the data unit 120 to the computing device 104, after identifying that route E is shorter in geographic distance to the computing device 104 than either routes D or F, based on the geotag field in the data unit 120. In this case, the switch controller 240 may reference the forwarding decision index 242 to identify geographic information for the network components 200-204, and evaluate the shortest route based on the geographic information. Alternatively or additionally, the switch controller 240 may reference the forwarding decision index 242 to identify routes to include or exclude. The routes may be chosen by the switch controller 240 to include or exclude routing or switching data units through certain municipalities, cities, states, countries, or regions thereof, for example.

With regard to the evaluation of a least distance route metric, geolocation information may be used in path bridging (e.g., IEEE 802.1aq) and related protocols, for example, as a parameter in shortest path calculations. In shortest path bridging, one or more network components in a network have a global view of the logical network membership in the network. Data units are encapsulated at the edge either in MAC-in-MAC 802.1ah or tagged 802.1Q/802.1ad frames and transported only to respective members of the logical network. To define the shortest path between two network components in a true geographic location sense, geographic location information may be relied upon as a parameter. In this case, shortest path calculations may be more accurate. The convergence of the network will be quicker since we have a ready parameter to compute the optimal path, because current computations do not have information of the location proximity. In one embodiment, a network component may embed its geolocation information shortest path bridging protocol frames, to exchange with other participating network components.

Further, with regard to geolocation-based QOS aspects, it is noted that geolocation information, such as source and destination geographic location information, may be used as a parameter for traffic classification. In various embodiments, any of the headers or QOS-related fields described herein, or a combination thereof, may be used to specify a traffic quality classification. That is, data units communicated to or from certain geographic locations may be given a relatively higher priority treatment. For example, data units originating from a region in which a disaster has occurred may be classified as high priority and given special treatment at a global scale regardless of physical and/or logical addresses of the data units. In another case, data units originating from or directed to certain geographic locations may be identified and assigned to a non-priority traffic quality classification, filtered, or dropped.

Now that a framework of the concepts of geotagged communications have been described, further details related to variations on implementations of geotagged communications are described below. Among the embodiments described herein, various applications of geotagged communications are provided. Certain applications include, for example, geotag-based Ethernet frames; geotag-based VLANs, virtual routing and forwarding (VRF), and virtual private networks (VPNs); geotag-based forwarding, routing, and/or switching; geotag-based multiprotocol label switching (MPLS); geotag-based fault detection and isolation; geotag-based firewalls and fencing; geotag-based shortest path bridging; geotag-based quality of service communications and filtering; and geotag internetworking between and among wireless or mobile networks and wired networks. At least to some extent, each of the applications relies upon geotag fields in data units which are communicated over networks.

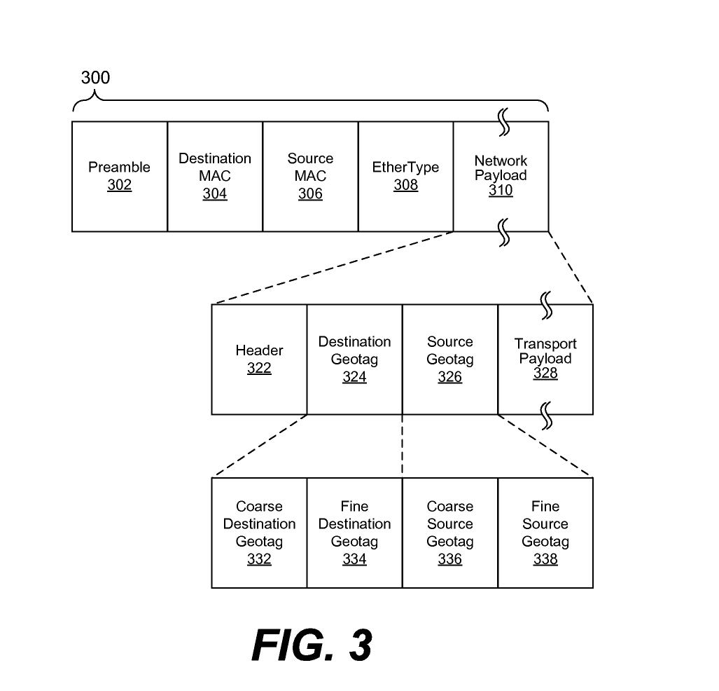

With regard to geotag-based Ethernet frames, FIG. 3 illustrates an example network data unit 300 which may be relied upon in geotagged communications in the system 10 of FIG. 1 according to an example embodiment. The data unit 300 includes a preamble 302, a destination MAC 304, a source MAC 306, an Ethertype field 308, and a network payload 310. The data unit 300 may be considered a layer 2 (i.e., OSI data layer 2) protocol data unit, and the network payload 310 may be considered a layer 3 (i.e., OSI network layer 3) service data unit of the data unit 300. As further illustrated in FIG. 3, the network payload 310 includes a header 322, a destination geotag field 324, a source geotag field 326, and a transport payload 328. Additionally, the destination geotag field 324 may include coarse and fine destination geotag fields 332 and 334, respectively, and the source geotag field 326 may include coarse and fine source geotag fields 336 and 338, respectively. The destination geotag field 324 and the source geotag field 326 may include encoded geographic latitude, longitude, and elevation information, for example, or at least a portion thereof, as described above.

In various embodiments, the destination and source geotag fields 324 and 326 may be inserted within geotag-based Ethernet frames (and other frames) at locations other than those illustrated in FIG. 3. That is, the arrangement of the destination and source geotag fields 324 and 326 among the other fields of the data unit 300 is illustrated in FIG. 3 by way of example, and the destination and source geotag fields 324 and 326 may be arranged at other positions (e.g., headers, MAC addresses, Ethertype fields, network payloads, etc.). Further, it should be appreciated that geotag fields may be used within or among various OSI layers, including the data, network, transport, and/or application layers, for example.

According to aspects of the embodiments described herein, a geotag Ethertype may be specified in the Ethertype field 308. In this case, when a geotag Ethertype is specified, the network component 200 may identify that the network payload 310 includes destination and source geotag fields 324 and 326. The network payload 310 may also include destination and source logical address fields (e.g., IPv4 or IPv6 addresses). Depending upon the needed level of accuracy in geolocation data, the destination geotag field 324 may include one or both of the coarse and fine destination geotag fields 332 and 334, and the source geotag field 326 may include one or both of the coarse and fine source geotag fields 336 and 338. Here, it is noted that geotag fields may be added to network data units without changing other aspects of the data units. In some embodiments, destination and source logical address fields (e.g., IPv4 or IPv6 addresses), for example, may be omitted from data units when geotag fields are used.

When the network component 200 receives a geotag Ethertype data unit, such as the data unit 300, the network component 200 parses the geotag fields 324 and 326. Rather than (or in addition to) performing data and/or network layer (e.g., layer 2 and/or layer 3) lookups using the forwarding decision index 242, the switch controller 240 may perform source and destination geolocation lookups. In turn, the switch controller 240 may evaluate the geolocation data in the forwarding decision index 242 in connection with the geotag fields 324 and 326, and identify a suitable egress port for forwarding the data unit 300. The selection of the egress port to forward the data unit 300 may be made by the switch controller 240 based on any of the path or route metrics described herein.

Other geolocation-aware network components in the network (e.g., network components 201-204) would also forward the data unit 300 along ports in the path of the destination location specified in the destination geotag field 324. To the extent necessary, upon approaching a final hop toward the destination location, a network component may evaluate standard layer 2 and/or layer 3 (e.g., MAC or IP address) lookups, to forward the data unit 300 to its final destination.

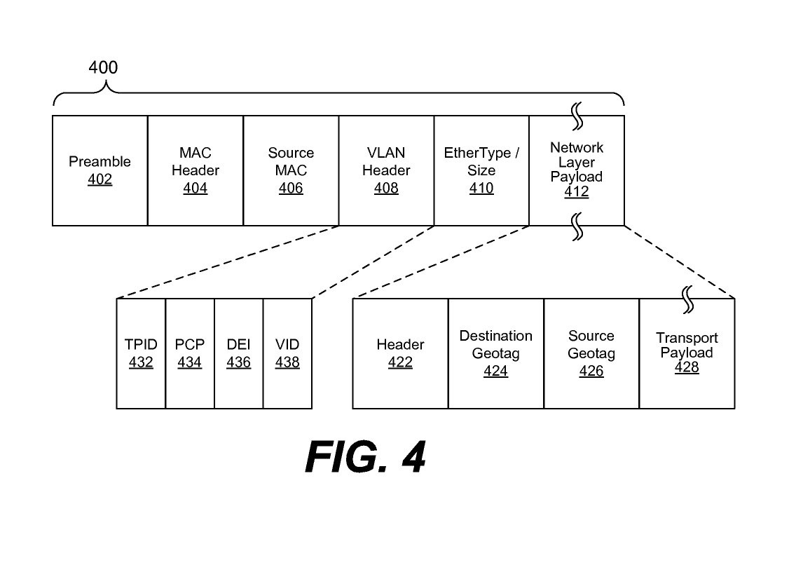

With regard to geotag-based VLANs, VRF, and VPNs, FIG. 4 illustrates an example network data unit 400 which may be relied upon in geotagged communications in the system 10 of FIG. 1 according to an example embodiment. The data unit 400 includes a preamble 402, a destination MAC 404, a source MAC 406, a VLAN header 408, an Ethertype field 410, and a network payload 412. The data unit 400 may be considered a layer 2 (i.e., OSI data layer 2) protocol data unit, and the network payload 412 may be considered a layer 3 (i.e., OSI network layer 3) service data unit of the data unit 300. As illustrated, the network payload 412 includes a header 422, a destination geotag field 424, a source geotag field 426, and a transport payload 428. In various embodiments, the destination and source geotag fields 424 and 426 may be inserted within the data unit 400 at locations other than those illustrated in FIG. 3. That is, the relative arrangement of the destination and source geotag fields 424 and 426 among the other fields of the data unit 400 is illustrated in FIG. 4 by way of example, and the destination and source geotag fields 424 and 426 may be arranged at other positions.

In one embodiment, the VLAN header 408 may be embodied as an IEEE 802.1Q header. In this context, it is noted the VLAN header 408 may be used to support the creation and maintenance of VLANs on a data network in connection with handling protocols used by network components. As further described below, the VLAN header 408 may be used to assign or associate the data unit 400 to a certain VLAN. Additionally, the VLAN header 408 may be used to designate a quality of service prioritization level for the data unit 400.

As illustrated in FIG. 4, the VLAN header 408 includes a tag protocol identifier (TPID) field 432, which may be relied upon by the network component 200 to identify the data unit 400 as an IEEE 802.1Q-tagged data unit. The VLAN header 408 further includes a priority code point (PCP) field 434, a drop eligible indicator (DEI) field 436, and a VLAN Identifier (VID) field 438. The PCP field 434 may refer to a priority or quality of service level for the data unit 400. For example, values of the PCP field 434 may range from 0 (lowest priority) to 7 (highest priority), and may be relied upon to prioritize different classes of traffic (e.g., voice, video, data, etc.) in VLANs. The DEI field 436 may be relied upon to indicate data units which are eligible to be dropped in the case of substantial network congestion, and the VID field 438 may be relied upon to specify a VLAN to which the data unit 400 belongs.

When a data unit is received at an ingress port of the network component 200 (FIG. 2), the network component 200 inserts the VLAN header 408 into the data unit, to provide the data unit 400. In this context, the VLAN header 408 indicates or identifies a VLAN membership for the data unit 400. In turn, the network component 200 (and other network components in the network) handles the data unit 400 to maintain the VLAN membership.

In one embodiment, to specify a VLAN membership, the VID field 438 may be assigned with geographic destination location information. For example, based on one or a combination of the geotag fields 424 and 426, the ingress port over which the data unit 400 was received, the destination and source MAC fields 404 and 406, etc., the network component 200 may assign the data unit 400 to membership in a certain VLAN using the VID field 438, where the VID field itself specifies a geographic destination, location, or geographic range. In this case, the network component 200 and other network components would forward or route the data unit 400 to ports that are in the path or within the geographic region of the geographically-identified VID field. In one aspect, specifying VLAN membership using geographic location information may be used to create broadcast or multicast domains based on geographic locations.

In another embodiment, the VID field 438 may be populated with a standard (i.e., non-geographic) VLAN identifier. In this case, the VLAN membership for the data unit 400 may be determined by the network component 200 based on one or a combination of the geotag fields 424 and 426, the ingress port over which the data unit 400 was received, the destination and source MAC fields 404 and 406, logical addresses associated with the data unit 400, or a protocol associated with the data unit 400, for example. In this case, the network component 200 and other network components would forward or route the data unit 400 to ports assigned, associated, or in the path of the VLAN identified in the VID field 438.

The network component 200 may assign data units from users at locations X, Y, and Z to the same VLAN membership, VLAN X, based on their relative or absolute geographic locations, with reference to a geographic VLAN fence defined in the filter index 244. If a user at location X moves to location Q, for example, which may be outside the boundaries of the geographic VLAN fence in the filter index 244, the network component 200 may identify that the user is no longer member of VLAN X. For example, the network component 200 may continue to conduct physical and logical address lookups for data units received from the user and, although the physical and/or logical address lookups may identify that the user was previously assigned or associated with VLAN X, the network component 200 may identify that the source geotag field 426 for data units received from the user are now outside the boundaries of the geographic VLAN fence in the filter index 244. In one embodiment, the network component 200 may drop data units which are specified for a physical address location that can no longer be reached because of geographic boundary VLAN disassociation.

In another aspect, the network component 200 may assign a quality of service level priority in the PCP field 434 of the data unit 400 based on one or a combination of the geotag fields 424 and 426. For example, the network component 200 may assign a relatively higher or lower priority in the PCP field 434 based on the geographic destination or source locations of the data unit 400 in the geotag fields 424 and 426. The priority may be assigned with reference to the filter index 244, which may define geographic locations which are to be attributed higher or lower priority in data transfer. In other embodiments, the network component 200 may assign a quality of service level priority in other fields of the data unit 400, such as the header 422, based on one or a combination of the geotag fields 424 and 426.

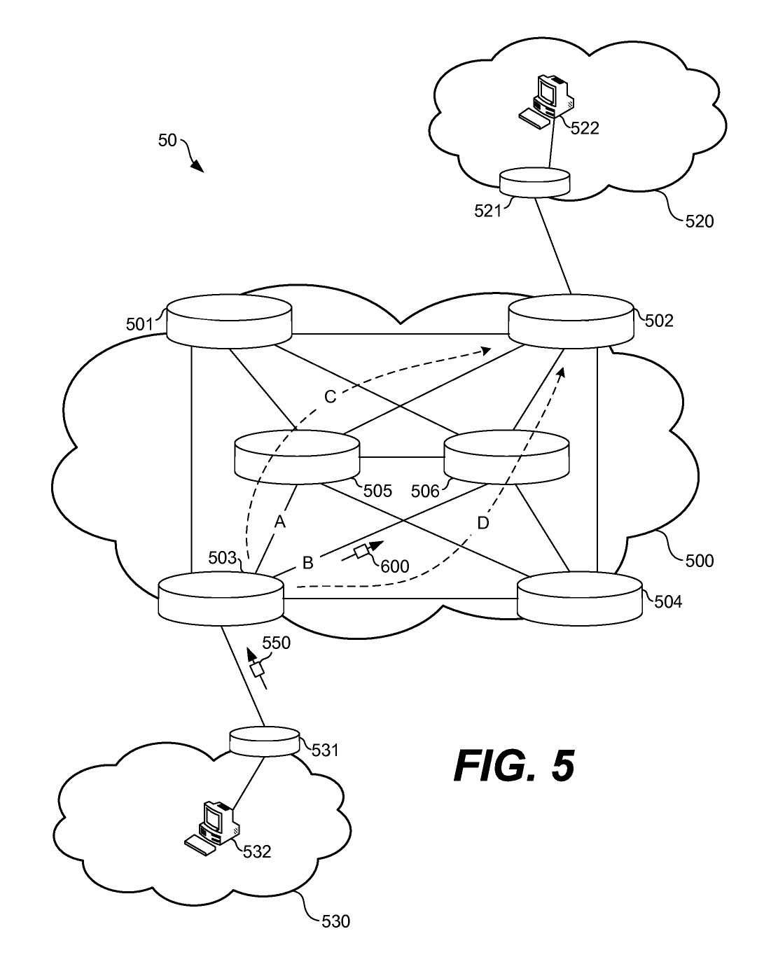

With regard to geotag-based MPLS (i.e., GTLS), FIG. 5 illustrates an example system 50 including a label switched network 500 and label switched network components that operate using geotagging according to an example embodiment. The system 50 includes the label switched network 500. The label switched network 500 includes label edge routers (LERs) 501-504 and label switching routers (LSRs) 505 and 506. The paths between the network elements in the label switched network 500 may be considered label switched paths (LSPs). The system 50 further includes the networks 520 and 530. The network 520 includes the network component 521 and the computing device 522, and the network 530 includes the network component 531 and the computing device 532. The network components 521 and 531 are embodied as geolocation aware network components and are similar to the network component 200 of FIG. 2. Further, the LERs 501-504 and the LSRs 505 and 506 are embodied as geolocation aware label switched network components and are similar to the network component 200 of FIG. 2, but operate using label switched forwarding, routing, or switching.

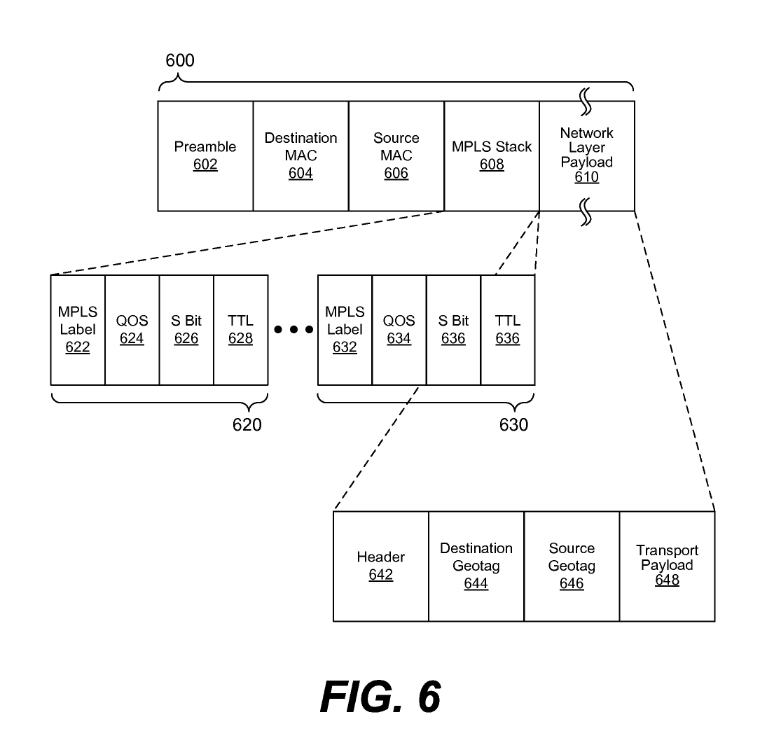

FIG. 6 illustrates an example network data unit 600 which may be relied upon in label switched geotagged communications in the system of FIG. 5 according to an example embodiment. Particularly, the data unit 600 may be communicated within the label switched network 500 in FIG. 5. The data unit 600 includes a preamble 602, a destination MAC 604, a source MAC 606, an MPLS stack 608, and a network payload 610. According to aspects of the embodiments described herein, the MPLS stack 608 may be generated or modified to include geolocation data. The data unit 600 may be considered a layer 2 (i.e., OSI data layer 2) protocol data unit, and the network payload 610 may be considered a layer 3 (i.e., OSI network layer 3) service data unit of the data unit 600. It is further noted that the data unit 600 may include one or more geotag fields which include geolocation data. The geotag field may be included at any location within the data unit 600, such as in the preamble 602 or in the network payload 610, for example. For example, the network payload 610 may include a header 642, a destination geotag field 644, a source geotag field 646, and a transport payload 648.

As illustrated, the MPLS stack 608 includes a first MPLS label 620 and a last MPLS label 630. It should be appreciated that any number of MPLS labels may be included within the MPLS stack 608. The first MPLS label 620 includes an MPLS label field 622, a quality of service (QOS) field 624, a bottom of stack S flag 626, and a time to live (TTL) field 628. The last MPLS label 630 includes an MPLS label field 632, a QOS field 634, a bottom of stack S flag 636, and a TTL field 638. The MPLS label fields 622 and 632 define a label for forwarding or routing, the QOS fields 624 and 634 define a quality of service level for the data unit 600, the bottom of stack S flags 626 and 636 identify a last MPLS label in the MPLS stack 608, and the TTL fields 628 and 638 define an amount of time which the data unit 600 may be stored until a forwarding path is resolved. As further described below, the MPLS stack 608 may be generated or modified to include geolocation data based on the destination and source geotag fields 644 and 646, for example.

Referring back to FIG. 6, the data unit 600 may be forwarded by the LER 503 in response to the receipt of a data unit 550 from the computing device 532 (via the network component 531). In turn, the LER 503 may generate the data unit 600 by inserting the MPLS stack 608 into the data unit received from the computing device 532. The data unit 550 may include a geotag field (i.e., the destination and source geotag fields 644 and 646) and/or physical and logical addresses specifying the computing device 522 as a destination. The generation of the MPLS stack 608 by the LER 503 based on the geotag field is described in further detail below.

Within the label switched network 500, the LSRs 504 and 505 may route the data unit 600 based on one or more of the MPLS labels in the MPLS stack 608. Typically, each MPLS label in the MPLS stack 608 specifies a next hop to an LSR. In the context of the embodiments described herein, the MPLS stack 608 includes geolocation data, for routing or switching. At each LSR, a top MPLS label may be popped from the MPLS stack 608, and the MPLS stack 608 is removed from the data unit 600 at an egress LER.

With regard to the generation of the MPLS stack 608 with geolocation data, it is noted that each of the LERs 501-504 may include a forwarding decision index similar to the forwarding decision index 242 of the network component 200 in FIG. 2. The forwarding decision indexes of the LERs 501-504 may organize and maintain the information by which paths in the label switched network 500 may be chosen. In this context, the LER 503 may generate the MPLS stack 608 with reference to its forwarding decision index. For example, the MPLS stack 608 may be generated by the LER 503 based on an evaluation of a least distance label switched hop metric, a least distance label switched route metric, a label switched geographic inclusion metric, a label switched geographic exclusion metric, or another label switched metric described herein.

With reference to the information stored in the forwarding decision index of the LER 503 and the geotag field in the data unit 550 (i.e., the destination and source geotag fields 644 and 646), the LER 503 may determine a next hop for the data unit 550 in the label switched network 500. This next hop may be encoded in the MPLS stack 608 of the data unit 600 using geolocation data, and the data unit 600 may be directed towards the computing device 522 in this manner. If the LER 503 determines only a next hop for the data unit 600, the MPLS stack 608 may include only a single MPLS label. The hop may be determined based on an evaluation of a least distance label switched hop metric, a label switched geographic inclusion metric, or a label switched geographic exclusion metric, for example. Alternatively, the LER 503 may determine a route in the label switched network 500 for the data unit 600. The route may be determined based on an evaluation of a least distance label switched route metric, a label switched geographic inclusion metric, or a label switched geographic exclusion metric, for example. In this case, the MPLS stack 608 may include several MPLS labels.

As one example, the LER 503 may select path B for communication of the data unit 600 towards the computing device 522, after identifying that the LSR 506 is closer in geographic proximity to the computing device 522 than the LSR 505. In this context, the LER 503 may reference its forwarding decision index to identify geographic position information associated with each of the “next hop” LSRs 505 and 506. In turn, LER 503 may evaluate which of the LSRs 505 and 506 is closest in geographic proximity to the computing device 522. Using the information in its forwarding decision index, the LER 503 may select path B as a least distance hop, and encode this hop information in the MPLS stack 608.

Alternatively or additionally, the LER 503 may reference its forwarding decision index to identify one or more of the LSRs 505 and 506 to include or exclude. In other words, the LER 503 may be configured to route certain data units to certain geographic locations. The geographic locations may include certain municipalities, cities, states, countries, or regions thereof, for example. Alternatively, the LER 503 may be configured to avoid routing or switching certain data units to certain geographic locations. The geographic locations to exclude or avoid may include municipalities, cities, states, countries, or regions thereof, for example.

As another example, the LER 503 may select route D for communication of the data unit 600 to the computing device 522, after identifying that route D is shorter in geographic distance to the computing device 522 than route C, based on the geotag field information. In this case, the LER 503 may reference its forwarding decision index to identify geographic information for the LSRs 505 and 506, and evaluate the shortest route based on the geographic information.

Alternatively or additionally, the LER 503 may reference its forwarding decision index to identify routes to include or exclude. The routes may be chosen by the LER 503 to include or exclude routing or switching data units through certain municipalities, cities, states, countries, or regions thereof, for example. When identifying a route for the data unit 600, the LER 503 may populate and insert the MPLS stack 608 within the data unit 600, where the MPLS stack 608 includes an MPLS label for each hop in the route through the label switched network 500. In some embodiments, routing to include or exclude network components at certain geographic locations may be a service level agreement parameter for services provided to customers of the label switched network 500. In this sense, the LERs and LSRs in the label switched network 500 may adhere to the geographical routing, switching, and/or hopping requirements of the service level agreement.

Here, it should be appreciated that, it is not necessary for the LSRs in the label switched network 500 to be geolocation-aware network components in every embodiment. Instead, if the LERs specify every path through the label switched network 500 according to the geotagged communications concepts described above, the LSRs in the label switched network 500 may forward or route the data units according to the geolocation-defined MPLS stack without any need to operate with geolocation data.

Turning to another geolocation-based application, in the context of geotag-based fault detection and isolation, it is noted that some datacenters have scaled up several thousands of servers and network components. Thus, for such datacenters, operations, administration, and management (OA&M) functions are relied upon quickly locate and correct faults. With large datacenters, it becomes difficult for datacenter operators to locate faulty equipment for manual repair or replacement. In some OA&M processes, continuity check messages (CCMs) are transmitted periodically by each component in a network. These CCM messages are intercepted by neighboring components to identify a particular component is functioning properly. If a particular component stops receiving CCM messages from a neighboring component, a fault is identified.

This fault detection mechanism may be considered slow, however, because it relies upon subsequent components in the network to broadcast the fault using a control bit in the packet header of CCMs. Subsequently, link trace or loopback messages are used to locate the faulty component, which is time consuming. Using the geotagged communications concepts described herein, a geotag field may be used in CCMs to easily identify a physical location of a faulty network component.

For example, when connectivity to a network device is lost, proximately-located network components send defect notification messages to upstream and/or downstream components. These messages typically indicate the fault type and location in an OA&M message. According to aspects of the embodiments described herein, network components that detect failures may embed geotag fields in OA&M messages. These OA&M messages may be communicated across the O&AM layer of the network, so that an operator can quickly determine the location the faulty network device perform the appropriate replacement or repair.

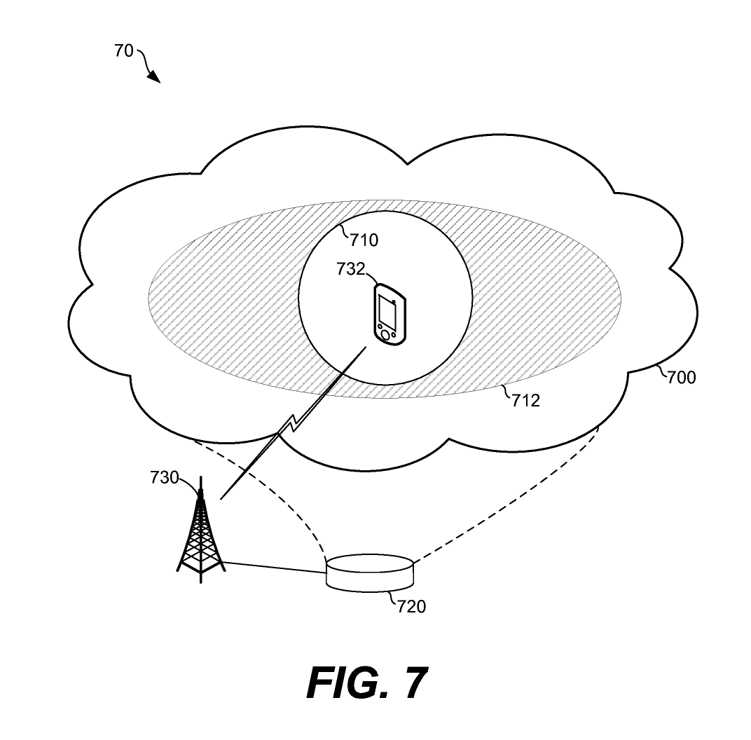

With regard to geotag-based firewalls and fencing, FIG. 7 illustrates an example system 70 including a network 700 that operates according to a geolocation firewall using geotagging according to an example embodiment. The system 70 includes the network 700, a wireless access point 730, and a communications device 732. The network 700 includes a first perimeter 710 and a second perimeter 712 and is generally provided or embodied by the network component 720 and the wireless access point 730. It is noted that the network component 720 and the wireless access point 730 may be representative of one or more network components, among embodiments. The first perimeter 710 and the second perimeter 712 correspond to geographic perimeters and are defined geographically, for example, by the network component 720. Based on the perimeters, the network component 720 forwards or routes data units within the network 700. It is noted that, in various embodiments, the network component 720 and the wireless access point 730 may or may not be geographically located or installed within the first perimeter 710 and the second perimeter 712.

The wireless access point 730 may be embodied as any suitable wireless communications access point, such as a WLAN access point or a cellular RRH, for example, without limitation. The communications device 732 may be embodied as any communications device capable of communicating data units to the wireless access point 730. It may be assumed that the communications device 732 includes a geolocation identifier and communicates data units including at least one geotag field, such as a destination or source geotag field as described herein. While certain geolocation firewall concepts are described below in the context of wireless communications, it should be appreciated that the concepts may be applied to wired devices in the network 700.

Geotag fields may be used to enhance firewall protection techniques, as provided by network components. Conventionally, firewall protection in network components has depended on physical and logical addressing and control protocols. According to aspects of geotagged communications described herein, geotags may be used to establish a virtual perimeter or geographic boundary (i.e., a “geofence”). A geolocation-aware network component, such as the network component 720, may generate a notification when the communications device 732 begins communicating data units from outside a certain geographic boundary or region. For example, the network component 720 may notify one or more network components, entities, or parties when the communications device 732 begins communicating data units from outside the first perimeter 710. The network component 720 may provide an additional notification when the communications device 732 begins communicating data units from outside the second perimeter 712. The network component 720 may refer to source location geotags of data units communicated by the communications device 732 in this context, to identify whether the communications device 732 is communicating from within or outside one of the perimeters 710 or 712.

The network component 720 may also classify data units with reference to the first perimeter 710 and the second perimeter 712. For example, the network component 720 may classify data units communicated from within the first perimeter 710 as having a high quality of service, and classify data units communicated from within the second perimeter 712 (but outside the first perimeter 710) as having a relatively lower quality of service. Further, the network component may drop data units which are communicated from a source geographic location outside the second perimeter 712. The network component 720 may refer to source location geotags of data units communicated by the communications device 732 in this context, to identify whether the communications device 732 is communicating from within or outside one of the perimeters 710 or 712.

In other embodiments, the network component 720 may allow limited access to the network 700 for data units communicated by the communications device 732 which are within the second perimeter 712 (but outside the first perimeter 710). For example, such data units may be assigned to a certain VLAN or limited to forwarding to certain ports, paths, or routes. Data units communicated by the communications device 732 from outside the second perimeter 712 may be assigned to a different VLAN. An alarm may be triggered in this case, to identify that data has entered the network from a geographic location outside the second perimeter 712. Different routing or quality of service policies, for example, may be applied to the data assigned to the different VLANs. In another aspect, the network component 720 may detect, block, or filter data units received from certain locations, based on source geographic location. In some cases, even if an attacker spoofs a source geographic location, the spoof may be detectable if inbound packets are expected to be sourced from within a range of geographic locations.

In other aspects, it is noted that network components may rely upon geotags for verification purposes. In this context, it is noted that data security and integrity may be verified by using geotag fields in digital certificates, for example, and correlating the digital certificate geotag fields with “first-hop” geolocation information. For example, a party may embed a geotag field in a digital certificate, where the geotag field is associated with a geographic location of a certain service provider or a service provider's network. Then, the party may communicate the digital certificate with data to the service provider. In turn, a first node in the service provider's network may embed geolocation information into data units which carry the data. Afterwards, any application can validate the integrity of the data by comparing the geolocation information in the data and the geotag fields in the digital certificate.

In some mobile wireless networks, geolocation information is available for data units communicated by mobile devices. In many cases, this geolocation information may not be communicated or relied upon in wireless networks beyond the layer of the cellular base station or access point, for example. In one embodiment, the geolocation information from mobile devices may be embedded in geotag fields of data units and communicated across wired networks. In this manner, data from wireless networks may be provisioned for QOS over wired networks. In this way, network components may apply policies based on the geotag fields to ensure substantially equivalent QOS treatment in wired and wireless networks.

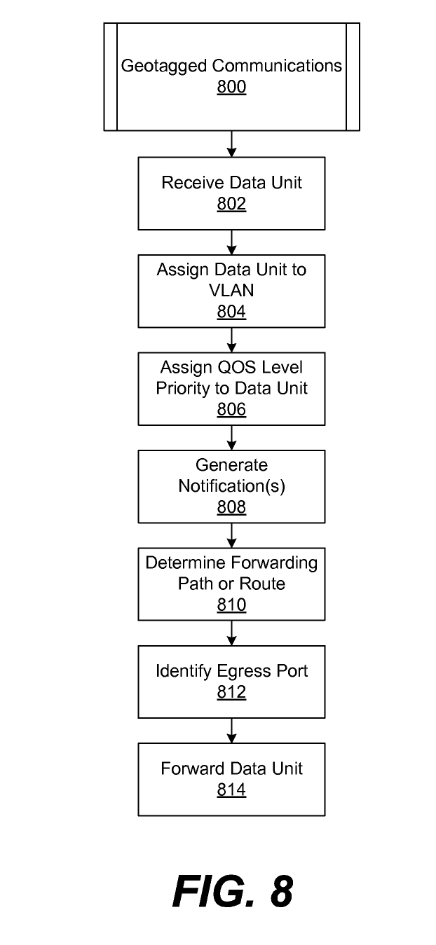

Before turning to the process flow diagram of FIG. 8, it is noted that the embodiments described herein may be practiced using an alternative order of the steps illustrated in FIG. 8. That is, the process flows illustrated in FIG. 8 are provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope and spirit of the embodiments.

FIG. 8 illustrates a process 800 of geotagged communications which may be performed by a network component described herein according to an example embodiment. It is noted that, although the process 800 is described in connection with one or more of the network components of FIG. 2, FIG. 5, or FIG. 7, the process 800 may be performed by other geolocation-aware network components.

At reference numeral 802, the process 800 includes receiving a data unit including a geotag field over an ingress port of a network component. For example, the data unit may be received by the network component 200 on one of the ingress ports ingress ports 210a-210n (FIG. 2). The data unit may include destination and/or source geotag fields, as described herein.

At reference numeral 804, the process 800 includes assigning the data unit to a VLAN based on the geotag field. In one embodiment, the assigning at reference numeral 804 may include assigning the data unit to the VLAN based on a combination of one or more of the geotag field, the ingress port, a media access control (MAC) identifier of the data unit, or a protocol associated with a payload of the data unit, as described above. For example, the network component 200 may insert a VLAN header into the data unit at reference numeral 802. In this context, the VLAN header may indicate or identifies a VLAN membership for the data unit. In turn, the network component 200 (and other network components) may handle the data unit to maintain the VLAN membership.

At reference numeral 806, the process 800 includes assigning a QOS level priority to the data unit. The network component 200 may assign the QOS level priority to the data unit according to any of the QOS level priority considerations described above. In various embodiments, any headers or QOS-related fields of the data unit may be used to specify a QOS level priority for the data unit. For example, data units communicated to or from certain geographic locations may be given a relatively higher priority treatment. Alternatively, data units originating from a region in which a disaster has occurred may be classified as high priority. In another case, data units originating from or directed to certain geographic locations may be identified and assigned to a non-priority traffic quality classification, filtered, or dropped.

At reference numeral 808, the process 800 includes generating one or more notifications. For example, the process 800 may include generating a notification when the geotag field indicates a source address for the data unit which is outside a certain geographic boundary or region, as described above with reference to FIG. 7. In other embodiments, the process 800 may include generating a notification when the geotag field indicates a source address for the data unit which is within a certain geographic boundary or region. The processes at reference numeral 808 may be performed by the network component 200, for example, based on or with reference to one or more virtual perimeters or geographic boundaries as described herein.

At reference numeral 810, the process 800 includes determining a forwarding path or route for the data unit based on the geotag field with reference to a forwarding decision index as described herein. For example, the network component 200 may determine a least distance hop for forwarding the data unit to a location associated with the geotag field with reference to the forwarding decision index. Alternatively or additionally, the network component 200 may determine a least distance route for routing or switching the data unit to a location associated with the geotag field with reference to the forwarding decision index, as described above. In other embodiments, when determining a route or path, the network component 200 may inset a label stack (e.g., an MPLS label stack) into the data unit, where the label stack identifies each hop along the least distance route.

At reference numeral 812, the process 800 includes identifying an egress port for the data unit based on the geotag field with reference to a forwarding decision index. For example, the egress port for the data unit may be identified at reference numeral 812 based on the forwarding path or route determined at reference numeral 810. Here, the network component 200 may identify one of the egress ports 212a-212n for forwarding the data unit based on the forwarding path or route determined at reference numeral 810.

At reference numeral 814, the process 800 includes forwarding the data unit over the egress port identified at reference numeral 812. In this case, because the forwarding path and egress port has been determined with reference to the geotag field, geotagged communication is achieved. Further, based on the aspects of geotagged communication in the process 800, geolocation data may be integrated into and relied upon in network components. As described herein, the geolocation data may be used to provide or enable geotag-based VLANs; geotag-based forwarding, routing, and/or switching; geotag-based multiprotocol label switching (MPLS); geotag-based fault detection and isolation; geotag-based firewalls and fencing; geotag-based shortest path bridging; and geotag-based quality of service communications and filtering. At least to some extent, each of these applications may be enabled, at least in part, according to the process 800.

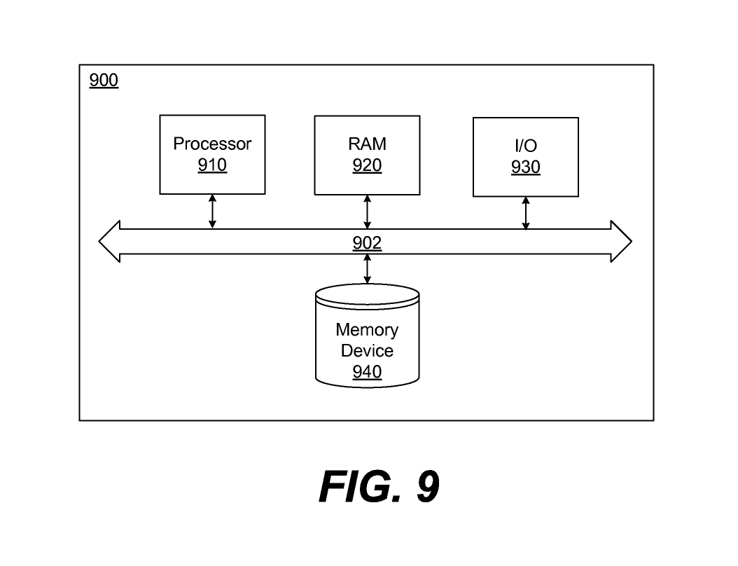

FIG. 9 illustrates an example schematic block diagram of a computing architecture 900 that may be employed by a network component (e.g., a network components of FIG. 2, FIG. 5, or FIG. 7) described herein according to various embodiments. The computing architecture 900 may be embodied, in part, using one or more elements of a mixed general and/or special purpose computer. The computing architecture 900 includes a processor 910, a Random Access Memory (RAM) 920, an Input Output (I/O) interface 930, and a memory device 940. The elements of computing architecture 900 are communicatively coupled via a local interface 902. The elements of the computing architecture 900 are not intended to be limiting in nature, as the architecture may omit elements or include additional or alternative elements.

In various embodiments, the processor 910 may include or be embodied as a general purpose arithmetic processor, a state machine, or an ASIC, for example. In various embodiments, the general- or specific-purpose processing circuits described herein may be implemented, at least in part, using the computing architecture 900 including the processor 910. The processor 910 may include one or more circuits, one or more microprocessors, ASICs, dedicated hardware, or any combination thereof. In certain aspects and embodiments, the processor 910 is configured to execute one or more software modules which may be stored, for example, on the memory device 940. In certain embodiments, the process 800 in FIG. 8 may be implemented or executed by the processor 910 according to instructions stored on the memory device 940.

The RAM 190 may include or be embodied as any random access and read only memory devices that store computer-readable instructions to be executed by the processor 910. The memory device 940 stores computer-readable instructions thereon that, when executed by the processor 910, direct the processor 910 to execute various aspects of the embodiments described herein.

As a non-limiting example group, the memory device 940 may include one or more non-transitory memory devices, such as an optical disc, a magnetic disc, a semiconductor memory (i.e., a semiconductor, floating gate, or similar flash based memory), a magnetic tape memory, a removable memory, combinations thereof, or any other known non-transitory memory device or means for storing computer-readable instructions. The I/O interface 930 includes device input and output interfaces, such as keyboard, pointing device, display, communication, and/or other interfaces. The one or more local interfaces 902 electrically and communicatively couple the processor 910, the RAM 920, I/O interface 930, and the memory device 940, so that data and instructions may be communicated among them.

In certain aspects, the processor 910 is configured to retrieve computer-readable instructions and data stored on the memory device 940 and/or other storage means, and copy the computer-readable instructions to the RAM 920 for execution. The processor 910 is further configured to execute the computer-readable instructions to implement various aspects and features of the embodiments described herein. For example, the processor 910 may be adapted or configured to execute the processes 800. In embodiments where the processor 910 includes a state machine or ASIC, the processor 910 may include internal memory and registers for maintenance of data being processed.

The flowchart or process diagrams of FIG. 8 are representative of certain processes, functionality, and operations of embodiments described herein. Each block may represent one or a combination of steps or executions in a process. Alternatively or additionally, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as the processor 910. The machine code may be converted from the source code, etc. Further, each block may represent, or be connected with, a circuit or a number of interconnected circuits to implement a certain logical function or process step.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Therefore, at least the following is claimed:

1. A method, comprising:
receiving a data unit including a geotag field over an ingress port of a network component;
identifying, by a processing circuit, an egress port for the data unit based on the geotag field and with reference to a forwarding decision index; and
forwarding the data unit over the egress port.

2. The method of claim 1, further comprising:
determining a least distance hop for forwarding the data unit to a location associated with the geotag field with reference to the forwarding decision index, wherein
identifying the egress port comprises identifying the egress port based on the least distance hop.

3. The method of claim 1, further comprising:
determining a least distance route for routing the data unit to a location associated with the geotag field with reference to the forwarding decision index, wherein
identifying the egress port comprises identifying the egress port based on the least distance route.

4. The method of claim 3, further comprising, before forwarding the data unit, inserting a label stack into the data unit, the label stack identifying each hop along the least distance route.

5. The method of claim 1, further comprising assigning the data unit to a virtual local area network (VLAN) based on the geotag field.

6. The method of claim 5, wherein the assigning comprises assigning the data unit to the VLAN based on a combination of one or more of the geotag field, the ingress port, a media access control (MAC) identifier of the data unit, or a protocol associated with a payload of the data unit.

7. The method of claim 1, further comprising assigning a quality of service level priority to the data unit based on the geotag field.

8. The method of claim 1, further comprising generating a notification when the geotag field indicates a source address for the data unit which is outside a certain geographic boundary or region.

9. A network component, comprising:
an ingress port that receives a data unit including a geotag field;
a network core that identifies a forwarding path for the data unit based on the geotag field and with reference to a forwarding decision index; and
an egress path that forwards the data unit.

10. The network component of claim 9, wherein the network core further determines a least distance hop for forwarding the data unit to a location associated with the geotag field with reference to the forwarding decision index.

11. The network component of claim 9, wherein the network core further determines a least distance route for routing the data unit to a location associated with the geotag field with reference to the forwarding decision index.

12. The network component of claim 11, wherein the network core further inserts a label stack into the data unit, the label stack identifying each hop along the least distance route.

13. The network component of claim 9, wherein the network core further assigns the data unit to a virtual local area network (VLAN) based on the geotag field.

14. The network component of claim 13, wherein the network core assigns the data unit to the VLAN based on a combination of one or more of the geotag field, the ingress port, a media access control (MAC) identifier of the data unit, or a protocol associated with a payload of the data unit.

15. The network component of claim 9, wherein the network core further assigns a quality of service level priority to the data unit based on the geotag field.

16. The network component of claim 9, wherein the network core further generates a notification when the geotag field indicates a source address for the data unit which is outside a certain geographic boundary or region.

17. A method, comprising:
receiving a data unit including a geotag field;
determining a least distance forwarding path for the data unit based on the geotag field and with reference to a forwarding decision index; and
forwarding the data unit.

18. The method of claim 17, wherein determining a least distance forwarding path comprises determining a least distance hop for forwarding the data unit to a location associated with the geotag field.

19. The method of claim 17, wherein determining a least distance forwarding path comprises determining a least distance route for forwarding the data unit to a location associated with the geotag field.

20. The method of claim 17, further comprising assigning the data unit to a virtual local area network (VLAN) based on a combination of one or more of the geotag field, a media access control (MAC) identifier of the data unit, or a protocol associated with a payload of the data unit.
